(19) United States
(12) Patent Application Publication
(10) Pub. No.: US 2015/0162616 A1
(43) Pub. Date: Jun. 11, 2015

(54) SECONDARY BATTERY

(71) Applicant: NEC Corporation, Tokyo (JP)

(72) Inventors: Hideaki Sasaki, Tokyo (JP); Takehiro Noguchi, Tokyo (JP)

(73) Assignee: NEC Corporation, Tokyo (JP)

(21) Appl. No.: 14/413,929

(22) PCT Filed: Jul. 8, 2013
(86) PCT No.: PCT/JP2013/068690

§ 371 Date: Jan. 9, 2015

(30) Foreign Application Priority Data
Jul. 11, 2012 (JP) 2012-155730

(51) Int. Cl. H01M 4/62; H01M 4/04; H01M 4/505

(52) U.S. Cl. CPC H01M 4/623; H01M 4/505; H01M 4/0404

(57) ABSTRACT

The present invention relates to a binder containing a chlorinated polyvinyl chloride resin (CPVC), and an electrode for lithium ion secondary batteries and a lithium ion secondary battery having the binder.

### TECHNICAL FIELD

The present invention relates to a binder for lithium ion secondary batteries, and an electrode for lithium ion secondary batteries and a lithium ion secondary battery using the binder.

### BACKGROUND ART

A lithium ion secondary battery is small in volume, has a large capacity density per mass, can work at a high voltage, and therefore is widely adopted as a power source for small devices. The lithium ion secondary battery is used as, for example, a power source for mobile devices such as a cellular phone and a notebook-sized personal computer. Moreover, in recent years, application of the lithium ion secondary battery, other than the application to small mobile devices, to large secondary batteries in the field of electric vehicles (EV), electric power storage, or the like where a large capacity with long life is required has been expected due to the concern for environmental issues and improvement in consciousness of energy conservation.

An electrode of a secondary battery is an electrode in which an electrode mixture layer is formed on the collector, and the electrode mixture layer is constituted of an active material, a conductive assistant, a binder, and so on. The binder has a function of adhering the active material mutually and adhering the active material to the collector, and it is desired from the standpoint of battery performance, easiness of compatibility with battery production process, and so on that the binder has higher basic properties such as electrochemical stability, resistance to electrolyte solutions, adhesiveness, and heat resistance. On the other hand, it is also desired that the materials are as inexpensive as possible to meet the recent requirement of cost reduction for large batteries.

In negative electrodes of the lithium ion secondary batteries, there has been often used aqueous binders containing simultaneously a latex of rubber such as styrene butadiene rubber (SBR) and a thickener such as CMC, in addition to solvent-based binders containing polyvinylidene fluoride (PVDF) or the like. On the other hand, in positive electrodes, binders other than PVDF or fluoropolymers having a composition close to that of PVDF have hardly been put into practical use.

PVDF has high performances in properties such as oxidation resistance, heat resistance, adhesiveness, and resistance to electrolyte solutions, and is excellent in balance among these properties. Moreover, when PVDF is used, it is easy to obtain an electrode slurry having a favorable coating property. However, there have been problems that the resin price of PVDF is as high as around 2000 yen/kg and higher than those of other resins and PVDF has a drawback in terms of alkali resistance. On the other hand, no material that can be substituted for PVDF in terms of properties has been found yet, and it is the present state that PVDF has been used for long years.

As a binder other than PVDF, Patent Literature 1 discloses for example that polyvinyl chloride (PVC) is used as a binder containing a halogen element in the same way as PVDF. Moreover, in Patent Literature 2 and Patent Literature 3, polyvinyl chloride is listed as an example of the binder. Polyvinyl chloride (PVC) is a general-purpose resin and is very inexpensive.

### CITATION LIST

### Patent Literature

### Patent Literature 1: Japanese Patent Laid-Open No. 2000-348729

### Patent Literature 2: Japanese Patent Laid-Open No. 2000-323131

### Patent Literature 3: Japanese Patent Laid-Open No. 2000-048805

### SUMMARY OF INVENTION

### Technical Problem

However, according to the studies made by the present inventors, polyvinyl chloride (PVC) is inferior to PVDF in any of adhesiveness, oxidation resistance and heat resistance. The battery performance and the compatibility with battery production process are not sufficient. In fact, in the present state, PVC has not been turned into practical use as an electrode binder yet.

Thus, the object of the present invention is to provide a binder for secondary batteries having such performance that can be substitution for PVDF, with satisfying inexpensiveness, and an electrode and a secondary battery using the binder.

### Solution to Problem

The binder for secondary batteries according to the present embodiment contains a chlorinated polyvinyl chloride resin (hereinafter, sometimes referred to as “CPVC”).

### ADVANTAGEOUS EFFECTS OF INVENTION

According to the present embodiment, a secondary battery that is inexpensive, easily compatible with the existing electrode production process, and excellent in capacity retention ratio in charge and discharge cycles can be provided by using a chlorinated polyvinyl chloride resin (CPVC) as an electrode binder.

### BRIEF DESCRIPTION OF DRAWING

FIG. 1 is a cross sectional view illustrating an example of a secondary battery according to the present embodiment.

### DESCRIPTION OF EMBODIMENTS

[Binder]

The present inventors have made diligent studies to solve the problems to find out that a chlorinated polyvinyl chloride resin (CPVC) obtained by further chlorinating a polyvinyl chloride resin has a property suitable for a binder for secondary batteries and exhibits such battery performance that can be substitution for PVDF. The price of CPVC is about ⅕ or less of the price of PVDF, and thereby a secondary battery that is low-cost and is excellent in life performance can be provided. Herein, when the terms “binder for secondary batteries”, “binder for lithium ion secondary batteries” or simply “binder” is written in the present specification, all these terms mean a binder that can be used for either one of the positive electrode and the negative electrode or a binder that can be used for both electrodes unless explicitly noted.

Furthermore, the present inventors have found out the degree of polymerization and the chlorine content in CPVC that are more suitable for using as a binder for secondary batteries. Moreover, the present inventors have also found out that, by using a binder obtained by mixing CPVC with an appropriate amount of PVDF, the adhesive strength of electrodes can be more enhanced and the compatibility with battery production process can be improved more.

Hereinafter, the binder for secondary batteries that is used for the present embodiment will be described in detail.

CPVC contained in the binder for secondary batteries that is used for the present embodiment can be obtained by chlorinating a polyvinyl chloride resin (PVC). The polyvinyl chloride resin may contain another monomer that is polymerizable with vinyl chloride.

In the present embodiment, the degree of polymerization of CPVC is not particularly limited, however it is preferable that the degree of polymerization of CPVC is 500 or more, more preferably 1000 or more, and preferably 10000 or less. When the degree of polymerization of CPVC is 500 or more, the adhesiveness among mutual active materials and adhesiveness of the active material to the collector are more excellent.

It is preferable that the chlorine content in CPVC is larger than the chlorine content in PVC (56.8 mass %) and less than the chlorine content in polyvinylidene chloride (PVDC) (73.2 mass %) obtainable by replacing the whole fluorine in PVDF with chlorine, more preferably 60 mass % or more and 70 mass % or less, further more preferably 62 mass % or more and 67 mass % or less. When the chlorine content in CPVC is too high, there occurs an adverse effect that the adhesiveness to the collector by the binder becomes lowered or it becomes hard to dissolve CPVC in a solvent such as NMP.

PVC has a chlorine content of 56.8 mass % but has a low softening temperature as low as 60 to 80° C. On the other hand, the production of the electrode for lithium ion secondary batteries is usually carried out through a drying step at a temperature of 100° C. or more in order to evaporate a solvent for electrode slurry, such as N-methylpyrrolidone (NMP). Moreover, the lithium ion secondary battery is liable to be adversely influenced by moisture, and therefore it sometimes occurs a case where drying of the electrode or battery is conducted at a temperature of about 50 to about 100° C. before or after assembling the battery. Accordingly, when a resin, such as PVC, having a softening temperature remarkably lower than 100° C. is used as a binder, there is sometimes a case where peeling in the electrode or change in thickness occurs in these steps to cause problems in production.

On the other hand, with respect to CPVC, the softening temperature can be raised in proportion to the chlorine content therein, and therefore the required heat resistance can be secured by adjusting the chlorine content. Specifically, when the chlorine content in CPVC is increased by 1 mass %, the softening temperature rises by about 5° C. Accordingly, when the chlorine content in CPVC is set to about 60 mass %, the softening temperature becomes about 90 to about 100° C., and therefore it is anticipated that it becomes easy to apply CPVC to lithium ion secondary battery production process.

The reason why the oxidation resistance of PVDF that is widely used as a binder is high is because PVDF contains fluorine that is a halogen element. PVC and CPVC also contain chlorine that is a halogen element. The fluorine content in PVDF here is 59.4 mass %, meanwhile the chlorine content in PVC is 56.8 mass %, and thus the mass ratio of the halogen element is lower in PVC than in PVDF. Also, PVC is considered to be inferior to PVDF in oxidation resistance from the fact that the fluorine atom has a higher electronegativity than the chlorine atom and tends to have a higher oxidation resistance than the chlorine atom. On the other hand, CPVC has a higher chlorine content than PVC and therefore is superior to PVC in oxidation resistance. Accordingly, also from the standpoint of the oxidation resistance, CPVC is more advantageous than PVC as a binder, and it is preferable that the chlorine content in CPVC is equal to or higher than the fluorine content in PVDF, namely 60 mass % or more.

In the present embodiment, a commercially available product can be used as CPVC, and Sekisui CPVC (trade name, manufactured by Tokuyama Sekisui Co., Ltd.) and Kaneka CPVC (trade name, manufactured by Kaneka Corporation) are sold on the market.

As described above, CPVC has such advantageous effects that can be substitution for PVDF used so far, and can also reduce the cost.

In the present embodiment, the binder may contain another compound other than CPVC. The CPVC content is not particularly limited, however it is preferable that the CPVC content in the total mass of the positive electrode binder or in the total mass of the negative electrode binder is 10 mass % or more and 100 mass % or less, more preferably 30 mass % or more and 100 mass % or less, more preferably 10 mass % or more and 70 mass % or less, further more preferably 30 mass % or more and 70 mass % or less.

As a binder of the present embodiment, CPVC and PVDF may arbitrarily be mixed and used. By mixing CPVC with PVDF, the heat resistance, the oxidation resistance, and the adhesiveness of electrodes can further be improved. Since the cost of electrodes increases as the PVDF content is increased, it is preferable to properly control the cost and properties taking the balance therebetween into consideration, and, for example, it is preferable that the proportion of PVDF based on the total amount of CPVC and PVDF is 10 mass % or more and 70 mass % or less, more preferably 50 mass % or less. When the proportion of PVDF is 10 mass % or more, it becomes easy to make improvement effect on adhesive strength.

Moreover, since PVDF is vulnerable to an alkali, there has been a problem that the electrode slurry is gelled, for example, in the case where a material having a high alkalinity, such as lithium nickelate is used. On the other hand, since CPVC has a high alkali resistance, a favorable electrode slurry can be obtained even with a material having a high alkalinity without such a problem of gelation. Accordingly, a binder containing CPVC can be used more suitably even in the electrode containing lithium nickelate.

The binder containing CPVC can be used as a binder for either one of the positive electrode and the negative electrode or a binder for both electrodes, and it is more preferable to use the binder containing CPVC as a binder for a positive electrode.

It is preferable that the positive electrode in the present embodiment comprises the binder containing the above-mentioned CPVC and/or PVDF, and it is more preferable that the positive electrode in the present embodiment comprises the binder containing CPVC and PVDF. Or, a fluororesin, an acrylic resin, or the like other than PVDF may be used as a positive electrode binder, and these resins may be mixed and used with CPVC and/or PVDF. The positive electrode binders may be used alone or in combination of two or more kinds.

It is preferable that the negative electrode in the present embodiment comprises the binder containing the above-mentioned CPVC and/or PVDF. Moreover, a fluororesin, an acrylic resin, or the like other than PVDF may be used, and these resins may be mixed and used with CPVC and/or PVDF. Or, together with these binders or in place of these binders, a rubber compound such as styrene butadiene rubber (SBR) can be used. In the case of using the rubber compound, a thickener such as carboxymethyl cellulose (CMC) or a sodium salt thereof can be used together with the rubber compound.

[Secondary Battery]

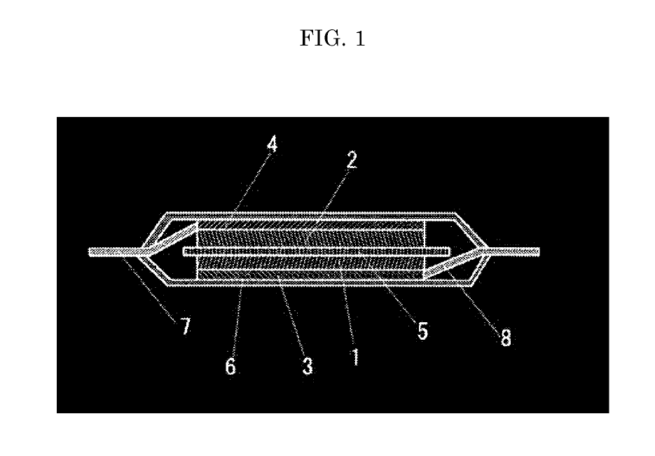

The secondary battery in the present embodiment is not particularly limited as long as the secondary battery comprises an electrode having a binder containing CPVC as a positive and/or negative electrode. A laminate type secondary battery is illustrated in FIG. 1 as an example of the secondary battery according to the present embodiment. In the secondary battery illustrated in FIG. 1, a separator 5 is sandwiched between the positive electrode and the negative electrode, wherein the positive electrode comprises a positive electrode active material layer 1 containing the positive electrode active material and the positive electrode binder and a positive electrode collector 3 and the negative electrode comprises a negative electrode active material layer 2 containing the negative electrode active material that can occlude and release lithium and a negative electrode collector 4. The positive electrode collector 3 is connected to a positive electrode tab 8, and the negative electrode collector 4 is connected to a negative electrode tab 7. A laminated outer package 6 is used as an outer package, and the inside of the secondary battery is filled with a nonaqueous electrolyte solution.

[Positive Electrode]

The positive electrode of the secondary battery according to the present embodiment is not particularly limited, however the positive electrode is obtained by, for example, forming a positive electrode active material layer on at least one face of the positive electrode collector. The positive electrode active material layer is not particularly limited, however the positive electrode active material layer contains, for example, a positive electrode active material, a positive electrode binder, and a conductive assistant.

(Positive Electrode Active Material)

The positive electrode active material contained in the positive electrode of the secondary battery according to the present embodiment is not particularly limited, however a lithium-containing composite oxide can be used. As the lithium-containing composite oxide, LiM1O2 (M1 is at least one element selected from the group consisting of Mn, Fe, Co, and Ni, and a part of M1 may be substituted with Mg, Al, or Ti), LiMn₂₋ₓM2ₓO₄ (M2 is at least one element selected from the group consisting of Mg, Al, Co, Ni, Fe, and B, and 0≦x≦2), and so on can be used. Moreover, an olivine type material represented by LiFePO₄ can also be used. These materials may have a non-stoichiometric composition such as a Li excess composition. These materials may be used alone or in combination of two or more kinds. Among these materials, despite that lithium manganate represented by the aforementioned LiMn₂₋ₓM2ₓO₄ has lower capacity than lithium cobaltate (LiCoO₂) and lithium nickelate (LiNiO₂), the lithium manganate is of low material cost because the output of production of Mn is larger than that of Ni and Co, and it has high heat stability because it has a spinel structure. Therefore, lithium manganate is preferable as a positive electrode active material for a large secondary battery for electric vehicles, electric power storage, and so on. For example, 15 to 35 mass % of lithium nickelate can be mixed and used with lithium manganate. Thereby, the battery capacity can be enhanced while maintaining the heat stability as a positive electrode.

(Positive Electrode Binder, Conductive Assistant, and Collector)

As a positive electrode binder, the above-mentioned binders can be used.

Examples of the conductive assistant used for a positive electrode include carbon black, graphite, and carbon fiber. These may be used alone or in combination of two or more kinds.

As a positive electrode collector, aluminum, stainless steel, nickel, titanium, alloys thereof, or the like can be used.

It is preferable that the amount of the positive electrode binder relative to the total mass of the positive electrode active material, the positive electrode binder, and the conductive assistant is 1 mass % or more and 10 mass % or less, more preferably 2 mass % or more and 6 mass % or less.

(Method for Producing Positive Electrode)

The method for producing a positive electrode is not particularly limited, however, for example, the positive electrode active material, the positive electrode binder, and the conductive assistant are dispersed and kneaded in a prescribed blending amount in a solvent such as NMP, and the resultant positive electrode slurry is applied on the positive electrode collector. The positive electrode slurry can appropriately be dried or subjected to heat treatment, and thereby the positive electrode active material layer can be formed on the positive electrode collector. In addition, the positive electrode active material layer may appropriately be compressed by a roll press method or the like in order to adjust the density of the positive electrode active material layer.

[Negative Electrode]

The negative electrode of the secondary battery according to the present embodiment is not particularly limited but is obtained by, for example, forming a negative electrode active material layer on at least one face of the negative electrode collector such as copper foil. The negative electrode active material layer contains at least a negative electrode active material, and a negative electrode binder, and a conductive assistant as necessary.

(Negative Electrode Active Material)

The negative electrode active material contained in the negative electrode of the secondary battery according to the present embodiment is not particularly limited, and, for example, carbon materials such as graphite or amorphous carbon can be used, however it is preferable to use graphite from the viewpoint of energy density. As a negative electrode active material, materials that form an alloy with Li such as Si, Sn, and Al; Si oxides; Si composite oxides containing Si and another metal element other than Si; Sn oxides; Sn composite oxides containing Sn and another metal element other than Sn; and Li₄Ti₅O_{12,} or composite materials in which the above-described materials are covered with carbon; or the like can also be used. The negative electrode active materials can be used alone or in combination of two or more kinds. It is preferable that the negative electrode active material has an average particle diameter (D50) of 5 to 50 μm, more preferably 10 to 30 μm. It is preferable that the negative electrode active material has a specific surface area of 0.5 to 5 m²/g, more preferably 0.5 to 2 m²/g.

(Negative Electrode Binder, Conductive Assistant, and Collector)

As a negative electrode binder, the above-described binders can be used.

Examples of the conductive assistant that is used for the negative electrode include high crystalline carbon, carbon black, and carbon fiber. These conductive assistants may be used alone or in combination of two or more kinds.

As a negative electrode collector, copper, stainless steel, nickel, titanium, alloys thereof, or the like can be used.

It is preferable that the amount of the negative electrode binder relative to the total mass of the negative electrode active material, the negative electrode binder, and the conductive assistant is 1 mass % or more and 15 mass % or less, more preferably 1 mass % or more and 8 mass % or less.

(Method for Producing Negative Electrode)

The method for producing the negative electrode is not particularly limited, however, for example, the negative electrode slurry is prepared in the first place by dispersing and kneading the negative electrode active material, the negative electrode binder and the conductive assistant as necessary in a prescribed blending amount in a solvent. Generally as a solvent of the negative electrode slurry, an organic solvent such as NMP is used in the case where the fluorine compound and/or chlorine-containing compound is used as a negative electrode binder, and water is used in the case where the rubber compound is used as a negative electrode binder. The negative electrode can be produced by coating the negative electrode collector with the negative electrode slurry and drying it. The electrode density of the obtained negative electrode can be adjusted by compressing the negative electrode active material layer by a roll press method or the like.

(Nonaqueous Electrolyte Solution)

The nonaqueous electrolyte solution is not particularly limited, however a solution obtained by dissolving a lithium salt in a nonaqueous solvent for example can be used.

Examples of the lithium salt include LiPF₆, lithium imide salts, LiAsF₆, LiAlCl₄, LiClO₄, LiBF₄, and LiSbF₆. Examples of the lithium imide salt include LiN(CₖF₂ₖ₊₁SO₂)(CₘF₂ₘ₊₁SO₂) (k and m each independently represent 1 or 2). These lithium salts may be used alone or in combination of two or more.

As a nonaqueous solvent, at least one solvent selected from the group consisting of cyclic carbonates, chain carbonates, aliphatic carboxylic acid esters, γ-lactones, cyclic ethers, and chain ethers can be used. Examples of the cyclic carbonate include propylene carbonate (PC), ethylene carbonate (EC), butylene carbonate (BC), and derivatives thereof (including fluorinated compounds). Examples of the chain carbonate include dimethyl carbonate (DMC), diethyl carbonate (DEC), ethyl methyl carbonate (EMC), dipropyl carbonate (DPC), and derivatives thereof (including fluorinated compounds). Examples of the aliphatic carboxylic acid ester include methyl formate, methyl acetate, ethyl propionate, and derivatives thereof (including fluorinated compounds). Examples of the γ-lactone include γ-butyrolactone and derivatives thereof (including fluorinated compounds). Examples of the cyclic ether include tetrahydrofuran, 2-methyltetrahydrofuran, and derivatives thereof (including fluorinated compounds). Examples of the chain ethers include 1,2-diethoxy ethane (DEE), ethoxy methoxy ethane (EME), diethyl ether, and derivatives thereof (including fluorinated compound). As a nonaqueous solvent, dimethyl sulfoxide, 1,3-dioxolane, formamide, acetoamide, dimethylformamide, dioxolane, acetonitrile, propionitrile, nitromethane, ethyl monoglyme, phosphoric acid triester, trimethoxy methane, dioxolane derivatives, sulfolane, methyl sulfolane, 1,3-dimethyl-2-imidazolidinone, 3-methyl-2-oxazolidinone, 1,3-propane sultone, anisole, N-methyl pyrrolidone, and derivatives thereof (including fluorinated compounds) other than the above-described nonaqueous solvents can be used. These nonaqueous solvents may be used alone or in combination of two or more kinds.

It is preferable that the concentration of the lithium salt in the nonaqueous electrolyte solution is 0.7 mol/L or more and 1.5 mol/L or less. Sufficient ion conductivity can be obtained by setting the concentration of the lithium salt to 0.7 mol/L or more. Moreover, the viscosity can be reduced and the transfer of lithium ions is not inhibited by setting the concentration of the lithium salt to 1.5 mol/L or less.

Moreover, the nonaqueous electrolyte solution may contain an additive for the purpose of forming an SEI (Solid Electrolyte Interface) film of good quality on the surface of the negative electrode. The SEI film has a function of suppressing the reactivity with the electrolyte solution and smoothing the desolvation reaction associated with the insertion and desorption of the lithium ions to prevent the deterioration of the structure of the negative electrode active material. Examples of the additive include propane sultone, vinylene carbonate, and cyclic disulfonic acid esters. These additives may be used alone, or in combination of two or more kinds.

It is preferable that the concentration of the additive in the nonaqueous electrolyte solution is 0.2 mass % or more and 5 mass % or less relative to the total mass of the electrolyte solution. Sufficient SEI film can be formed by the concentration of the additive being 0.2 mass % or more. Moreover, the resistance can be lowed by the concentration of the additive being 5 mass % or less.

(Positive Electrode Tab and Negative Electrode Tab)

The positive electrode tab and the negative electrode tab are not particularly limited, however, at least one selected from the group consisting of Al, Cu, phosphor bronze, Ni, Ti, Fe, brass, stainless steel for example can be used as a material for the positive and negative electrode tabs.

(Separator)

The separator is not particularly limited, however porous films formed of polyolefins such as polypropylene and polyethylene or fluororesins or the like can be used as a separator. Also, cellulose or an inorganic separators such as a glass separator may be used.

(Outer Package)

The outer package is not particularly limited, however cans such as coin shaped, square shaped, and cylindrical cans or laminated outer packages can be used as an outer package. Among these cans or laminated outer packages, a laminated outer package that is a flexible film formed of a laminate of a synthetic resin and a metal foil is preferable because reduction in weight is possible and the energy density of secondary batteries can be increased. The laminate type secondary battery comprising a laminated outer package is excellent in the heat dissipation property and therefore is suitable for a battery for cars such as an electric vehicle.

(Method for Producing Secondary Battery)

The method for producing the secondary battery according to the present embodiment is not particularly limited, and an example of the method is shown below. The positive electrode tab and the negative electrode tab are respectively connected to the positive electrode and the negative electrode, respectively via the positive electrode collector and the negative electrode collector. The positive electrode and the negative electrode are disposed opposite to each other for lamination with the separator interposed therebetween to prepare an electrode laminate. The electrode laminate is housed in the outer package and immersed in the electrolyte solution. The secondary battery is prepared by sealing the outer package so that a part of the positive electrode tab and a part of the negative electrode tab are protruded to the outside.

### EXAMPLES

Hereinafter, examples of the present embodiment will be described in detail, however the present embodiment is not limited to the following examples.

### Example 1

(Preparation of Negative Electrode)

A negative electrode slurry was prepared by kneading and dispersing graphite powder (average particle diameter (D50): 22 μm, specific surface area: 1.0 m²/g) as a negative electrode active material and PVDF as a negative electrode binder uniformly in NMP so that the mass ratio of the respective solid content became 95.0:5.0. The negative electrode slurry was applied on copper foil having a thickness of 15 μm, the copper foil being a negative electrode collector. Thereafter, a negative electrode active material layer was formed by drying at 125° C. for 10 minutes to evaporate NMP. A negative electrode was prepared by pressing the negative electrode active material layer. In addition, the mass of the negative electrode active material layer per unit area after drying was set to 0.008 g/cm².

(Preparation of Positive Electrode)

LiMn₂O₄ powder (average particle diameter (D50): 15 μm, specific surface area: 0.5 m²/g) as a positive electrode active material was provided. A positive electrode slurry was prepared by dispersing the positive electrode active material, CPVC (HA-53K manufactured by Tokuyama Sekisui Co., Ltd., degree of polymerization 1000, chlorine content 67.3 mass %) as a positive electrode binder, and carbon black as a conductive assistant in a mass ratio of 91:4:5 uniformly in NMP. The positive electrode slurry was applied on aluminum foil having a thickness of 20 μm, the aluminum foil being a positive electrode collector. Thereafter, a positive electrode active material layer was formed by drying at 125° C. for 10 minutes to evaporate NMP, and a positive electrode was prepared by pressing the positive electrode active material layer. Herein, the mass of the positive electrode active material layer per unit area after drying was set to 0.024 g/cm².

(Nonaqueous Electrolyte Solution)

A nonaqueous electrolyte solution was prepared by mixing EC and DEC in a ratio of EC:DEC=30:70 (volume %) to obtain a nonaqueous solvent and dissolving LiPF₆ as an electrolyte so that the concentration of LiPF₆ became 1 mol/L. To the nonaqueous electrolyte solution, 1.5 mass % of vinylene carbonate as an additive was added.

(Preparation of Secondary Battery)

The prepared positive electrode and negative electrode were cut out to a size of 5 cm×6 cm, respectively. In each of the cut-out electrodes, a part with side lengths of 5 cm×1 cm was left as a part where an electrode active material layer was not formed (unapplied part) for the purpose of connecting a tab, and the size of the part where the electrode active material layer was formed was 5 cm×5 cm. A positive electrode tab of aluminum having a width 5 mm×a length 3 cm×a thickness 0.1 mm was welded to the unapplied part of the positive electrode with a welding length of 1 cm by ultrasonic welding. A negative electrode tab of nickel the size of which was the same as the size of the positive electrode tab was welded to the unapplied part of the negative electrode by ultrasonic welding. An electrode laminate was obtained by disposing the negative electrode and the positive electrode on both faces of a separator having a size of 6 cm×6 cm and formed of polyethylene and polypropylene so that the electrode active material layers were overlapped across the separator. Three sides excluding one longer side of two aluminum laminate films each having a size of 7 cm×10 cm were adhered with an adhesion width of 5 mm by heat fusion to prepare a bag-shaped laminated outer package. The electrode laminated body was inserted into the bag-shaped laminated outer package so that the distance from one shorter side of the laminated outer package was 1 cm. Furthermore, 0.2 g of the nonaqueous electrolyte solution was injected and vacuum impregnation was performed, and thereafter the opening was sealed with a sealing width of 5 mm by heat fusion under reduced pressure. Thereby, a laminate type secondary battery was prepared.

(Adhesiveness of Electrode)

The occurrence/nonoccurrence and degree of peeling of the positive electrode mixture layer were evaluated by visual observation of the appearance of the positive electrode just before a tab was welded to the positive electrode in the production process of the secondary battery.

(First Charge and Discharge)

The prepared secondary battery was subjected to the first charge and discharge. First of all, charging was conducted up to 4.2 V at a constant current of 10 mA corresponding to 5 hour rate (0.2 C) at 20° C. Thereafter, charging at a constant voltage of 4.2 V was conducted for 8 hours in total. Thereafter, discharging was conducted at a constant current of 10 mA down to 3.0 V.

(Cycle Test)

Charging was applied up to 4.2 V at 1 C (50 mA) to the secondary battery after the first charge and discharge was applied. Thereafter, charging at a constant voltage of 4.2 V was conducted for 2.5 hours in total. Thereafter, discharging at a constant current was conducted down to 3.0 V at 1 C. The charge and discharge cycle was repeated 300 times at 55° C. The ratio of the discharging capacity after 300 cycles to the first discharging capacity was calculated as a capacity retention ratio (%).

### Example 2

A secondary battery was prepared and evaluated in the same manner as in Example 1 except that CPVC (HA-05K manufactured by Tokuyama Sekisui Co., Ltd., degree of polymerization 500, chlorine content 67.3 mass %) was used as a positive electrode binder.

### Example 3

A secondary battery was prepared and evaluated in the same manner as in Example 1 except that CPVC (HA-53F manufactured by Tokuyama Sekisui Co., Ltd., degree of polymerization 1000, chlorine content 64.0 mass %) was used as a positive electrode binder.

### Comparative Example 1

A secondary battery was prepared and evaluated in the same manner as in Example 1 except that PVC (TS-1000R manufactured by Tokuyama Sekisui Co., Ltd., degree of polymerization 1000, chlorine content 56.8 mass %) was used as a positive electrode binder.

### Comparative Example 2

A secondary battery was prepared and evaluated in the same manner as in Example 1 except that PVDF was used as a positive electrode binder.

Evaluation results of the state of peeling of the positive electrode by visual observation and the capacity retention ratio after 300 cycles at 55° C. for Examples 1 to 3 and Comparative Examples 1 and 2 are shown in Table 1. The CPVC content here is a mass ratio of CPVC to the employed positive electrode binder, and in the case where CPVC and PVDF are used together, the CPVC content is a value determined by (mass of CPVC)/(mass of CPVC+mass of PVDF)×100% (the same applies to Table 2).

The capacity retention ratio for Comparative Example 1 where PVC was used was as low as 57.2%. On the other hand, the capacity retention ratio for Examples 1 to 3 where CPVC was used was 69 to 70%, and thus the property that was in no way inferior to that of Comparative Example 2 where PVDF was used was obtained. It is found from the results that the cycle property is improved by using CPVC obtained by further chlorinating PVC.

On the other hand, with respect to the occurrence/nonoccurrence of peeling in the positive electrode examined by visual observation, peeling was not observed in Example 3 and Comparative Example 2, while partial peeling was observed at the end of the electrode in Examples 1 and 2 and Comparative Example 1. It is considered that this is because the adhesive strength between the positive electrode active material layer and the positive electrode collector was somewhat low and therefore partial peeling occurred at the edge of the positive electrode where deformation at the time of cutting the electrode was large. From the degree of peeling, the adhesive strength was determined to be in the order of Example 3>Comparative Example 1>Example 1>Example 2. Based on this, it is found that the adhesiveness becomes higher and is more preferable as the degree of polymerization of CPVC becomes larger. It is preferable from the standpoint of adhesiveness of the electrode that the degree of polymerization of CPVC is 500 or more, more preferably 1000 or more. It is considered that the function of binding the active material with the collector becomes sufficiently strong by setting the degree of polymerization to 1000 or more.

It was found that the adhesive strength tended to be lowered when the chlorine content was too high or too low. It is estimated that the adhesiveness is improved because the polarity within the polymer becomes high, which is caused by that a hydrogen atom and a chlorine atom in CPVC each having different electronegativity are present in an appropriate ratio. The number of atoms of fluorine (F) and the number of atoms of hydrogen (H) for PVDF are equal and F/H =1, however chlorine (Cl) is larger than fluorine in atomic weight and atomic radius and therefore it is anticipated that it is preferable for the ratio of the number of atoms of chlorine to the number of atoms of hydrogen (Cl/H) in CPVC becomes a value less than 1 in order to obtain the same effect as with PVDF.

TABLE 1

| | | | | | Occurrence/ | |
|---|---|---|---|---|---|---|
| | Positive electrode binder | | | | nonoccurrence | |
| | | | Chlorine | CPVC | of peeling in | Capacity |
| | | Degree of | content | content | positive | retention |
| | Compound | polymerization | (mass %) | (mass %) | electrode | ratio (%) |
| Ex. 1 | CPVC | 1000 | 67.3 | 100 | Slight | 69.6 |
| Ex. 2 | CPVC | 500 | 67.3 | 100 | Some | 69.1 |
| Ex. 3 | CPVC | 1000 | 64.0 | 100 | No | 69.9 |
| Com.-Ex. 1 | PVC | 1000 | 56.8 | 0 | Very slight | 57.2 |
| Com.-Ex. 2 | PVDF | — | — | 0 | No | 69.5 |

Ex. = Example
Com.-Ex. = Comparative Example

### Example 4

A secondary battery was prepared and evaluated in the same manner as in Example 1 except that CPVC (HA-53K manufactured by Tokuyama Sekisui Co., Ltd., degree of polymerization 1000, chlorine content 67.3 mass %) and PVDF were mixed and used as positive electrode binders so that the amount of each binder was 2 mass % relative to the total mass of the positive electrode active material, the positive electrode binders, and the conductive assistant.

### Example 5

A secondary battery was prepared and evaluated in the same manner as in Example 1 except that CPVC (HA-05K manufactured by Tokuyama Sekisui Co., Ltd., degree of polymerization 500, chlorine content 67.3 mass %) and PVDF were mixed and used as positive electrode binders so that the amount of each binder was 2 mass % relative to the total mass of the positive electrode active material, the positive electrode binders, and the conductive assistant.

### Example 6

A secondary battery was prepared and evaluated in the same manner as in Example 1 except that CPVC (HA-53F manufactured by Tokuyama Sekisui Co., Ltd., degree of polymerization 1000, chlorine content 64.0 mass %) and PVDF were mixed and used as positive electrode binders so that the amount of each binder was 2 mass % relative to the total mass of the positive electrode active material, the positive electrode binders, and the conductive assistant.

Evaluation results of the state of peeling of the positive electrode by visual observation and the capacity retention ratio after 300 cycles at 55° C. for Examples 4 to 6 are shown in Table 2. It is confirmed that peeling of the positive electrode was not observed at all in any of Examples and the adhesiveness of the electrode was improved. The value of the capacity retention ratio was favorable as high as 69 to 70% in any of Examples. It is found from the results that the adhesive strength of the electrode is able to be enhanced without impairing the battery performance by mixing PVDF in an appropriate amount with CPVC.

TABLE 2

| | Positive electrode binder | | | | Occurrence/ | |
|---|---|---|---|---|---|---|
| | | | Chlorine | | nonoccurrence | |
| | | Degree of | content | CPVC | of peeling in | Capacity |
| | | polymerization | in CPVC | content | positive | retention |
| | Compound | of CPVC | (mass %) | (mass %) | electrode | ratio (%) |
| Ex. 4 | CPVC + PVDF | 1000 | 67.3 | 50 | No | 69.8 |
| Ex. 5 | CPVC + PVDF | 500 | 67.3 | 50 | No | 69.1 |
| Ex. 6 | CPVC + PVDF | 1000 | 64.0 | 50 | No | 69.6 |

Ex. = Example

The thickness (D1) of the positive electrode mixture layer was measured immediately after each of the positive electrodes produced in Example 3 and Comparative Example 1 was pressed with a load of 4.5 ton/cm². The thickness (D2) of the positive electrode mixture layer was measured in the same manner after the electrode was dried in vacuum at 90° C. for 15 hours, and the change ratio of the electrode thickness was determined from (D2−D1)/D1×100%. As a result thereof, the change ratio for the positive electrode of Example 3 was 2.4%, meanwhile the change ratio for the positive electrode of Comparative Example 1 was very large, as large as 7.7%. It is thought that this is because PVC which was used in Comparative Example 1 had a low softening point and therefore the retention property of the electrode structure at elevated temperatures became lowered. When such a big change in thickness occurs, problems arises such as that the battery size becomes larger than the designed value, the battery capacity becomes lower than the designed value, or the like. It is found from this that using CPVC as a binder is also preferable from the standpoint of battery production process because the change in thickness is small.

### REFERENCE SIGNS LIST

1 Positive electrode active material layer
2 Negative electrode active material layer
3 Positive electrode collector
4 Negative electrode collector
5 Separator
6 Laminated outer package
7 Negative electrode tab
8 Positive electrode tab

1. A binder for lithium ion secondary batteries, comprising a chlorinated polyvinyl chloride resin (CPVC).

2. The binder for lithium ion secondary batteries according to claim 1, wherein the CPVC has a degree of polymerization of 500 or more.

3. The binder for lithium ion secondary batteries according to claim 1, wherein the CPVC has a degree of polymerization of 1000 or more.

4. The binder for lithium ion secondary batteries according to claim 1, wherein the CPVC has a chlorine content of 60 mass % or more and 70 mass % or less.

5. The binder for lithium ion secondary batteries according to claim 1, wherein the CPVC has a chlorine content of 62 mass % or more and 67 mass % or less.

6. The binder for lithium ion secondary batteries according to claim 1, further comprising polyvinylidene fluoride (PVDF).

7. The binder for lithium ion secondary batteries according to claim 1, wherein the binder has a CPVC content of 10 mass % or more and 70 mass % or less.

8. An electrode for lithium ion secondary batteries, comprising the binder for lithium ion secondary batteries according to claim 1.

9. The electrode for lithium ion secondary batteries according to claim 8, further comprising a positive electrode active material comprising lithium manganate.

10. The electrode for lithium ion secondary batteries according to claim 9, wherein the lithium manganate is represented by LiMn₂₋ₓM2ₓO₄ where M2 is at least one element selected from the group consisting of Mg, Al, Co, Ni, Fe and B, and 0≦x<2.

11. A lithium ion secondary battery, comprising the electrode for lithium ion secondary batteries according to claim 8.

12. A lithium ion secondary battery, comprising the electrode for lithium ion secondary batteries according to claim 8 as a positive electrode.

13. A method for producing an electrode for lithium ion secondary batteries, comprising a step of applying on a collector an electrode slurry obtained by kneading a binder comprising a chlorinated polyvinyl chloride resin (CPVC) with a positive electrode active material or a negative electrode active material.
